(19) United States
(12) Patent Application Publication
(10) Pub. No.: US 2026/0288483 A1
(43) Pub. Date: Sep. 24, 2026

(54) COMPUTER-IMPLEMENTED METHOD AND COMPUTING DEVICE

(71) Applicant: Renesas Electronics Corporation, Tokyo (JP)

(72) Inventors: Seisuke HIROSAWA, Tokyo (JP); Miyuki HOTTA, Tokyo (JP); Ayako ITOH, Tokyo (JP); Noriko SUZUKI, Tokyo (JP)

(21) Appl. No.: 19/456,605

(22) Filed: Jan. 22, 2026

(30) Foreign Application Priority Data
Mar. 24, 2025 (JP) 2025-048351

(51) Int. Cl. G06F 9/445

(52) U.S. Cl. CPC G06F 9/44505

(57) ABSTRACT

A technology that reduces the processing time of an operation device is provided. The processing executed by the DSP includes: receiving, by the DSP, input of a program; reading, by the DSP control driver, configuration information from the DSP module; matching the configuration information; uploading the configuration information to the DSP module if the program has been analyzed; and uploading the main part of the operation processing program to the DSP module.

### CROSS-REFERENCE TO RELATED APPLICATIONS

The disclosure of Japanese Patent Application No. 2025-048351 filed on March 24, 2025, including the specification, drawings and abstract is incorporated herein by reference in its entirety.

### BACKGROUND

The present disclosure relates to data processing, and more specifically, to techniques for reducing data processing time.

There are disclosed techniques listed below.

### Patent Document 1

Japanese Unexamined Patent Application Publication No. 2023-129549

In digital signal processors (DSP) and other processing devices, there is a demand to reduce data processing time. Regarding the reduction of data processing time, for example, Patent Document 1 discloses a processing device and startup method that can shorten the time until it becomes usable in the event of an error in software data (see Abstract).

### SUMMARY

A DSP uploads program data for data processing to a DSP module and executes that program. Therefore, the processing time for that data processing includes the time for uploading. Thus, there remains a need for improved techniques to reduce DSP processing time.

This specification discloses techniques for reducing DSP processing time.

According to one embodiment, a method executed by a computer is provided. This method includes: receiving, by a control unit of the computer, a request for operation processing; based on the fact that a plurality of functions for realizing the operation processing have been uploaded to the processing unit of the computer, uploading, by the control unit, to the processing unit, a main program that calls each of the plurality of functions and configuration information representing the configuration of the operation processing; and executing, by the processing unit, the main program and the plurality of functions according to the configuration information..

According to another embodiment, an operation device is provided. This operation device includes a control unit and a processing unit. The control unit receives a request for operation processing and uploads to the processing unit a main program that calls each of the plurality of functions and configuration information representing the configuration of the operation processing based on the fact that the plurality of functions for realizing the operation processing have been uploaded to the processing unit. The processing unit executes the main program and the plurality of functions according to the configuration information.

According to the aforementioned embodiment, the time for data processing by the computer is reduced.

### BRIEF DESCRIPTION OF THE DRAWINGS

FIG. 1 is a diagram illustrating a breakdown of data processing time.

FIG. 2 is a diagram illustrating a manner in which a program created by a user is executed by a DSP.

FIG. 3A is a diagram illustrating a manner in which three program data for realizing each data processing are executed by DSP230.

FIG. 3B is a diagram illustrating a manner in which three program data for realizing each data processing are executed by DSP230.

FIG. 4A is a diagram illustrating a manner in which five program data are executed by DSP440 having two DSP modules 460, 470.

FIG. 4B is a diagram illustrating a manner in which five program data are executed by DSP440 having two DSP modules 460, 470.

FIG. 5 is a diagram illustrating the operation of DSP540 according to one embodiment.

FIG. 6 is a flowchart representing a part of the processing executed by DSP540.

FIG. 7 is a diagram illustrating a manner of processing for making a program or function reside in DSP540.

FIG. 8 is a diagram illustrating a manner of processing executed when adding data processing to DSP540.

FIG. 9 is a diagram illustrating a manner of processing executed when adding data processing (Func_C) to DSP540.

FIG. 10 is a flowchart representing a part of the processing executed by DSP540 according to a certain aspect.

FIG. 11 is a diagram illustrating a manner of executing data processing in DSP540.

FIG. 12 is a flowchart representing a part of the processing for adding data processing by DSP540 according to another aspect.

FIG. 13 is a diagram illustrating a manner of executing data processing in DSP540 according to another aspect.

FIG. 14 is a flowchart representing a part of the processing executed when DSP540 deletes data processing based on user instructions according to another aspect.

FIG. 15 is a diagram illustrating a manner of executing data processing in DSP540 according to another aspect.

FIG. 16 is a flowchart representing a part of the processing executed by DSP1740 according to another aspect.

FIG. 17 is a diagram illustrating the configuration of DSP1740 and a manner of executing data processing.

FIG. 18 is a flowchart representing a part of the processing executed by DSP control driver 550 according to a certain aspect.

FIG. 19 is a diagram illustrating the configuration of DSP1940 and a part of the processing performed internally according to a certain aspect.

FIG. 20 is a flowchart representing a part of the processing executed by DSP control driver 550 according to another aspect.

FIG. 21 is a diagram illustrating the configuration of DSP1940 and a part of the processing performed internally according to another aspect.

### DETAILED DESCRIPTION

Below, embodiments of the technical ideas disclosed in this specification will be described with reference to the drawings. In the following description, the same reference numerals are assigned to the same components. Their names and functions are also the same. Therefore, detailed descriptions of them will not be repeated.

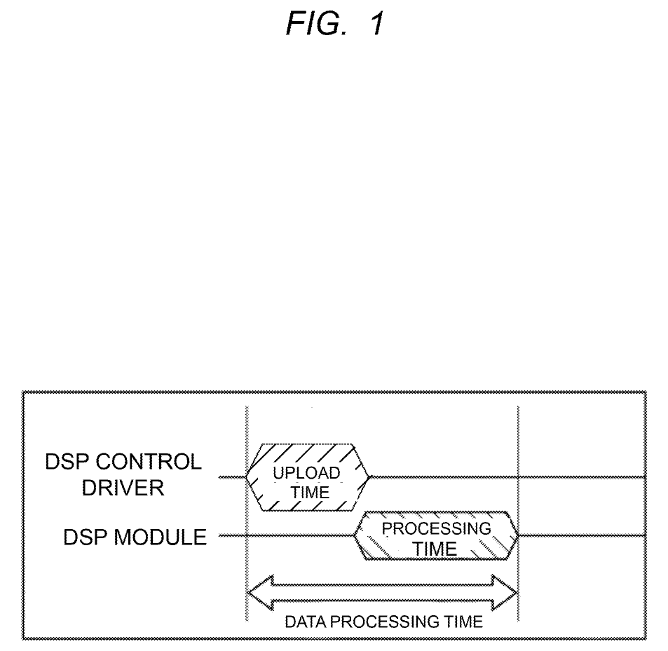

Referring to FIG. 1, the data processing time in a DSP (Digital Signal Processor) will be described. FIG. 1 is a diagram illustrating a breakdown of data processing time. The data processing time is divided into the upload time by the DSP control driver constituting the DSP and the processing time by the DSP module. The upload time is the time required for the DSP control driver to upload a program to the DSP module. The processing time is the time required for the DSP module to execute the program. When a DSP executes a program, upload time is required in addition to processing time.

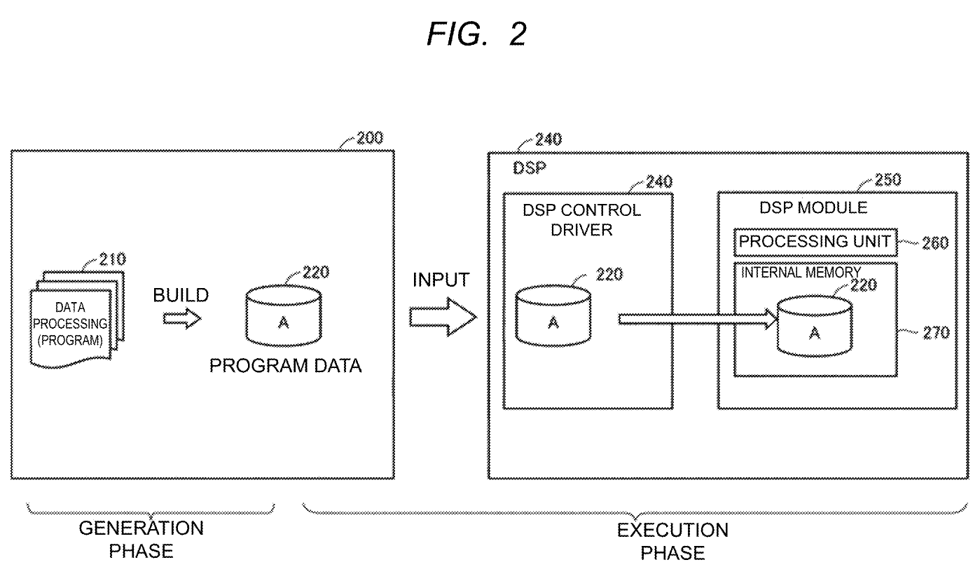

Referring to FIG. 2, an embodiment in which a DSP used in a System on a Chip (SoC) executes a program will be described. FIG. 2 is a diagram illustrating an embodiment in which a program created by a user is executed by a DSP.

### Generation Phase

The user builds program 210 that realizes operation processing on a computer 200 with a known configuration to generate program data 220. Program data 220 is, for example, binary data such as applications or libraries.

### Execution Phase

The user inputs program data 220 to DSP230 and requests DSP230 to execute program data 220. DSP control driver 240 uploads program data 220 to DSP module 250. Program data 220 is stored in internal memory 270 of DSP module 250. Processing unit 260 executes program data 220.

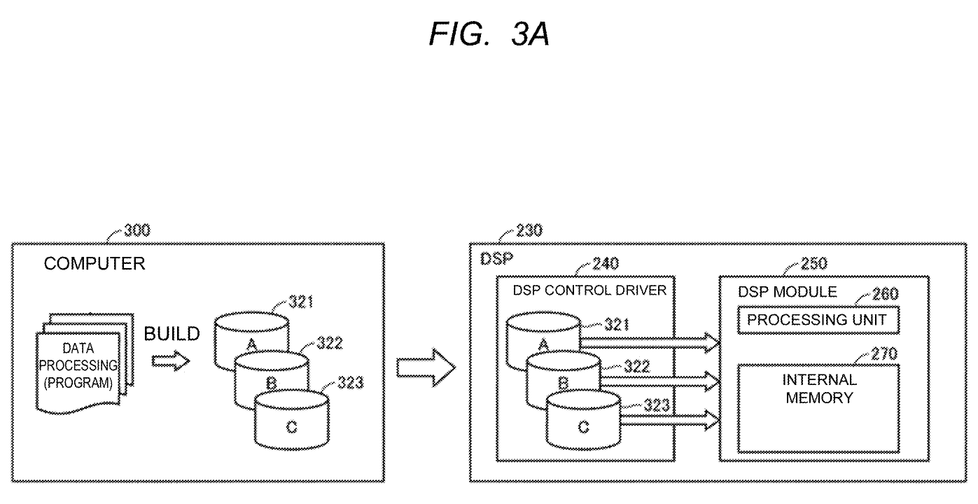

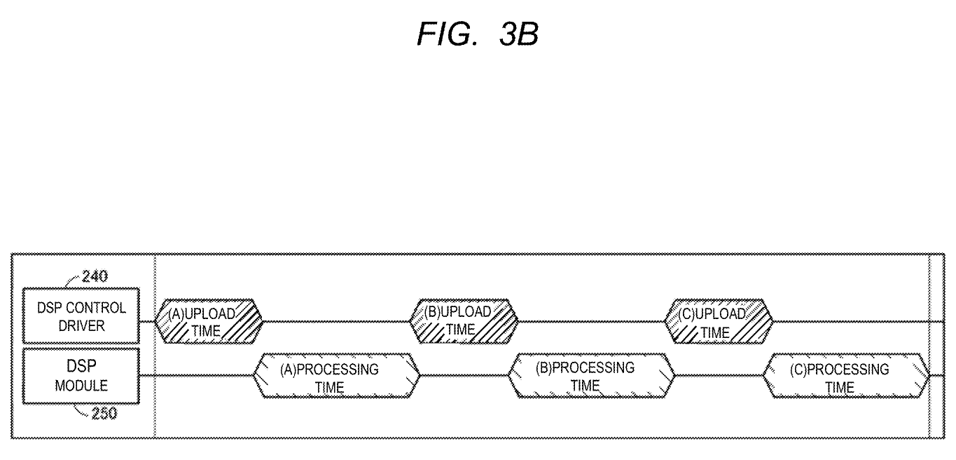

Referring to FIG. 3A and FIG. 3B, a case where a DSP executes multiple data processing operations will be described. FIG. 3A and FIG. 3B are diagrams illustrating an embodiment in which three program data for realizing each data processing are executed by DSP230.

As shown in FIG. 3A, in a certain aspect, the user operates a computer 300 with a known configuration to build three programs and generate three binary data 321, 322, 323. Computer 300 inputs binary data 321, 322, 323 to DSP230 and instructs DSP230 to execute them.

In DSP230, DSP control driver 240 uploads binary data 321, 322, 323 to DSP module 250, respectively. DSP module 250 stores binary data 321, 322, 323 in internal memory 270.

In this case, as shown in FIG. 3B, DSP module 250 uploads and executes binary data 321. Next, DSP module 250 uploads and executes binary data 322. Furthermore, DSP module 250 uploads and executes binary data 323. Therefore, when multiple data processing operations are executed, the data processing time increases by the number of times each binary data is uploaded.

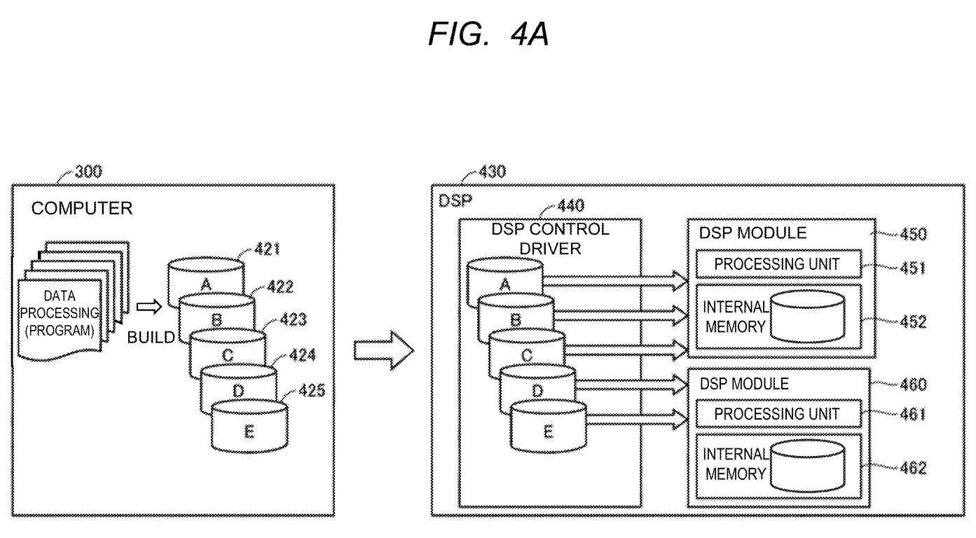

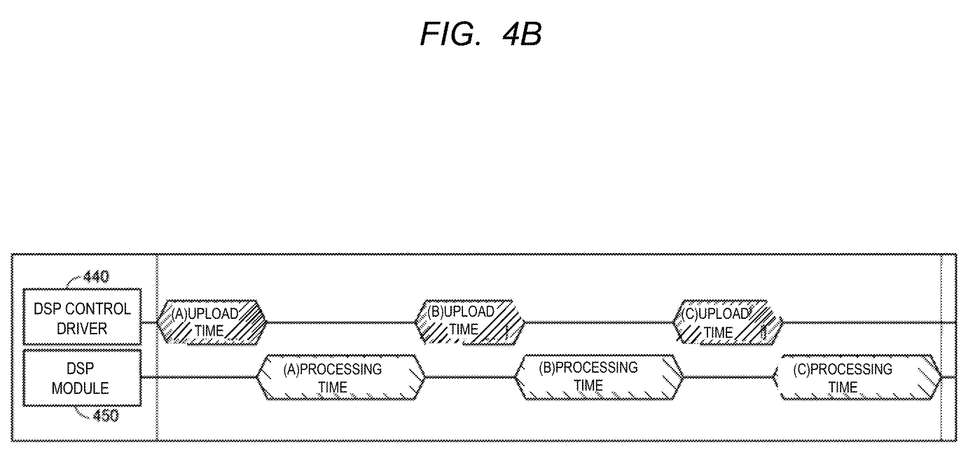

Referring to FIG. 4A and FIG. 4B, a case where a DSP has multiple DSP modules will be described. FIG. 4A and FIG. 4B are diagrams illustrating an embodiment in which five program data are executed by DSP440 having two DSP modules 460, 470.

As shown in FIG. 4A, in a certain aspect, the user operates computer 300 to build five programs and generate five binary data 421, 422, 423, 424, and 425. The user inputs binary data 421, 422, 423, 424, 425 to DSP430 and instructs DSP430 to execute them.

In DSP430, DSP control driver 440 uploads binary data 431, 422, 423 to DSP module 450 and uploads binary data 424, 425 to DSP module 460. DSP module 450 stores binary data 421, 422, 423 in internal memory 452. Processing unit 451 executes processing using binary data 421, 422, 423. DSP module 460 stores binary data 424, 425 in internal memory 462. Processing unit 461 executes processing using binary data 424, 425.

In this case, as shown in FIG. 4B, DSP module 450 uploads and executes binary data 421. Next, DSP module 450 uploads and executes binary data 422. Furthermore, DSP module 450 uploads and executes binary data 423. Therefore, when a DSP including multiple DSP modules executes multiple data processing operations, the data processing time increases by the number of times each binary data is uploaded.

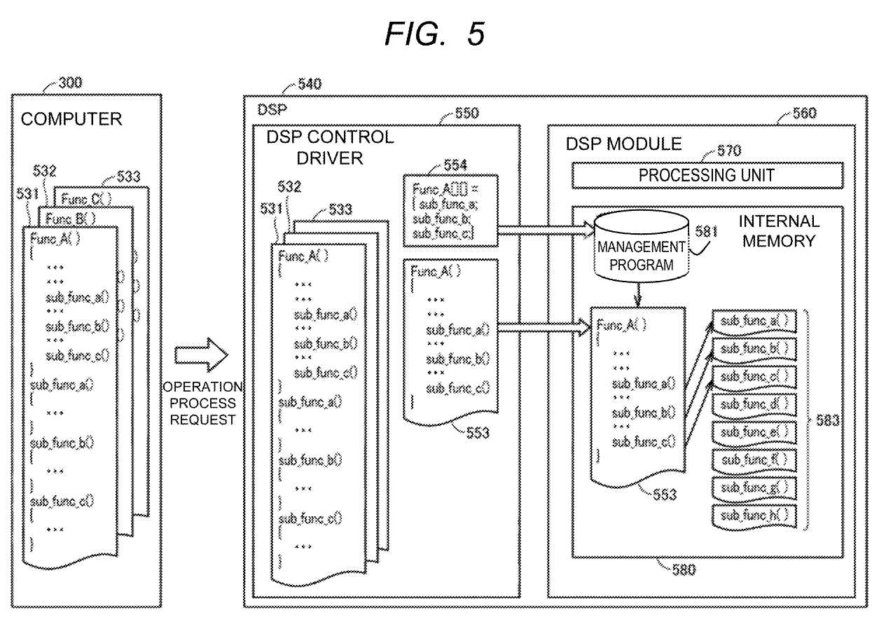

Referring to FIG. 5, a description will be given of DSP540 according to an embodiment. FIG. 5 is a diagram illustrating the operation of DSP540 according to an embodiment.

The user operates computer 300 to generate binary data 531, 532, 533 of functions that realize each operation processing (Func_A, Func_B, Func_C) to execute operation processing on DSP540. Each operation processing is composed of one or more functions (sometimes referred to as a "function group") that realize each processing. The user inputs binary data 531, 532, 533 from computer 300 to DSP540.

When DSP control driver 550 detects the input of binary data 531, 532, 533, it analyzes each binary data. DSP control driver 550 obtains configuration information of functions that perform operation processing from each binary data and stores the configuration information. DSP control driver 550 uploads the functions and a management program for managing the functions to DSP module 560. The function group 583 and the management program 581 reside in the internal memory 580 of DSP module 560 until they are deleted.

When the user requests the execution of operation processing from computer 300 to DSP540, DSP control driver 550 determines whether the functions necessary for the operation processing have already been uploaded to DSP module 560. If the functions have already been uploaded to DSP module 560, DSP control driver 550 uploads only the main part 553 and configuration information 554 of the operation processing to DSP module 560. This allows management program 581 to refer to configuration information 554 and execute the resident function group 583 from the main part 553.

DSP control driver 550 can execute operation processing by DSP module 560 with only the processing time to upload the main part 553 of the operation processing and input configuration information 554 to management program 581. Since the function group 583 that performs operation processing has already been uploaded and the entire function group does not need to be uploaded, the series of processing time is shortened by the upload time of function group 583.

In other situations, the function group 583 residing in DSP module 560 may be deleted if its usage frequency decreases or it becomes unnecessary, and new functions may be added as function group 583. Furthermore, if DSP540 has multiple DSP modules, DSP control driver 550 can interchange function groups between DSP modules according to the situation.

### Control Structure

### Input of Operation Processing

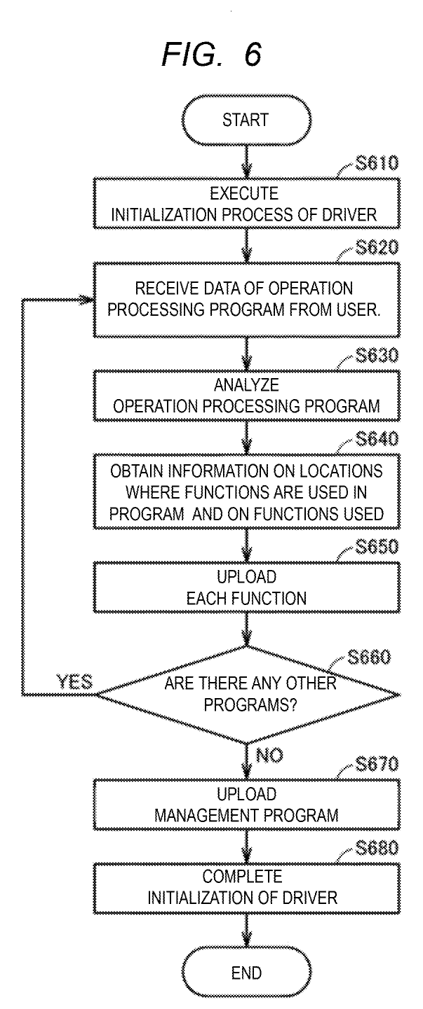

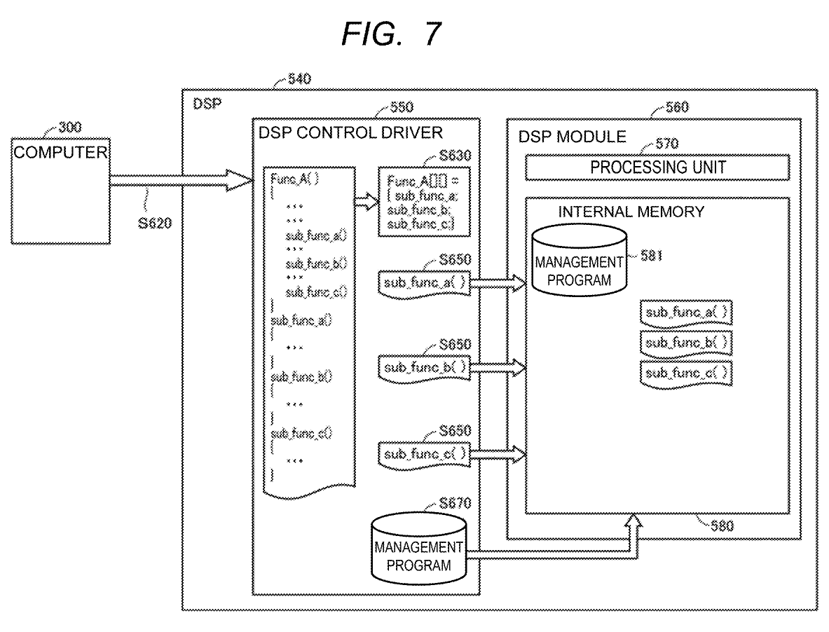

Referring to FIGS. 6 and 7, a description will be given of the control structure of DSP540 in a certain situation. FIG. 6 is a flowchart representing a part of the processing executed by DSP540. FIG. 7 is a diagram representing an aspect of the process of making a program or function reside in DSP540. Operation processing (Func_A) is composed of functions (sub_func_a, sub_func_b, sub_func_c) that realize the processing.

In step S610, DSP540 executes the initialization process of DSP control driver 550. In step S620, DSP540 receives data (binary data) of the operation processing program from the computer operated by the user. For example, if the user wishes to execute operation processing (Func_A), the binary data of the operation processing (Func_A) is input to DSP control driver 550.

In step S630, DSP control driver 550 analyzes the operation processing program (binary data of operation processing (Func_A)). In step S640, DSP control driver 550 obtains information on the locations where functions are used in the program and on the functions used and generates configuration information.

In step S650, DSP control driver 550 uploads each function (sub_func_a, sub_func_b, sub_func_c) to DSP module 560. Internal memory 580 stores the uploaded function group 583.

In step S660, DSP control driver 550 determines whether there are any other programs to be analyzed remaining. If DSP control driver 550 determines that there are other programs to be analyzed remaining (YES in step S660), it returns control to step S620 and executes the similar processing as described above. If not (NO in step S660), in step S670, DSP control driver 550 uploads management program 581 to DSP module 560.

In step S680, DSP540 ends the initialization of DSP control driver 550. This allows the function group that realizes operation processing (Func_A) to reside in DSP540. Operation unit 570 refers to management program 581 and executes each function to realize operation processing (Func_A).

### Addition of Operation Processing without Function Overlap

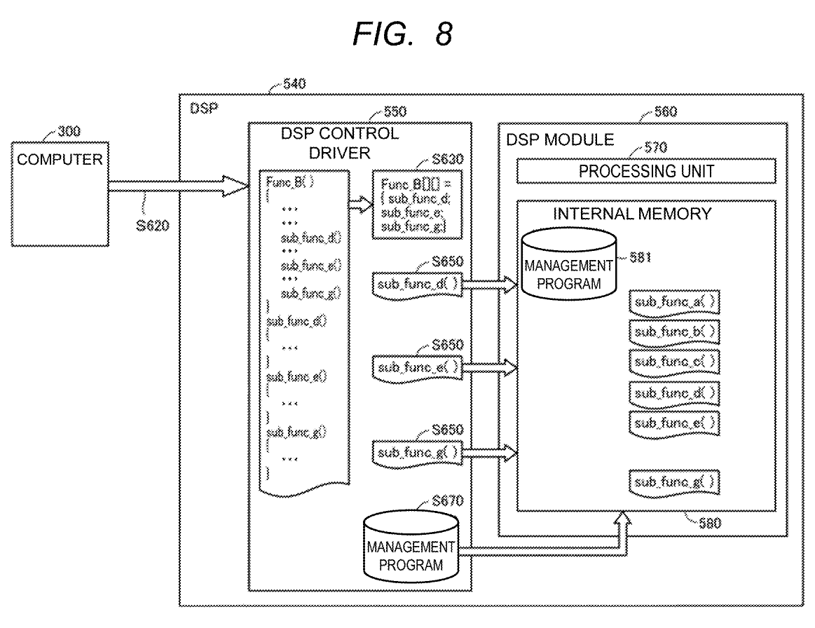

Referring to FIGS. 6 and 8, a description will be given of another control structure of DSP540 in a certain situation. FIG. 8 is a diagram representing an aspect of the process executed when adding operation processing to DSP540. Operation processing (Func_B) is composed of each function (sub_func_d, sub_func_e, sub_func_g) that realizes the processing. Also, the function group that composes Func_A and the function group that composes Func_B do not overlap. Note that the same numbers are assigned to the same processes as described above. Therefore, the description of the same process may not be repeated.

In step S620, DSP540 receives data (binary data) of the operation processing program from the computer operated by the user. For example, if the user wishes to execute operation processing (Func_B), the binary data of the operation processing (Func_B) is input to DSP control driver 550.

In step S630, DSP control driver 550 analyzes the operation processing program (binary data of operation processing (Func_B)). In step S640, DSP control driver 550 obtains information on the locations where functions are used in the program and on the functions used and generates configuration information.

In step S650, DSP control driver 550 uploads each function (sub_func_d, sub_func_e, sub_func_g) to DSP module 560. Internal memory 580 stores the uploaded functions.

In step S660, DSP control driver 550 determines whether there are any other programs to be analyzed remaining. If DSP control driver 550 determines that there are other programs to be analyzed remaining (YES in step S660), it returns control to step S620 and executes the similar processing as described above. If not (NO in step S660), in step S670, DSP control driver 550 uploads management program 581 to DSP module 560.

In step S680, DSP540 completes the initialization of DSP control driver 550. This allows the function group that realizes operation processing (Func_A and Func_B) to reside in DSP540. Operation unit 570 refers to management program 581 and executes functions to perform operation processing (Func_A and Func_B).

### Addition of Operation Processing with Function Overlap

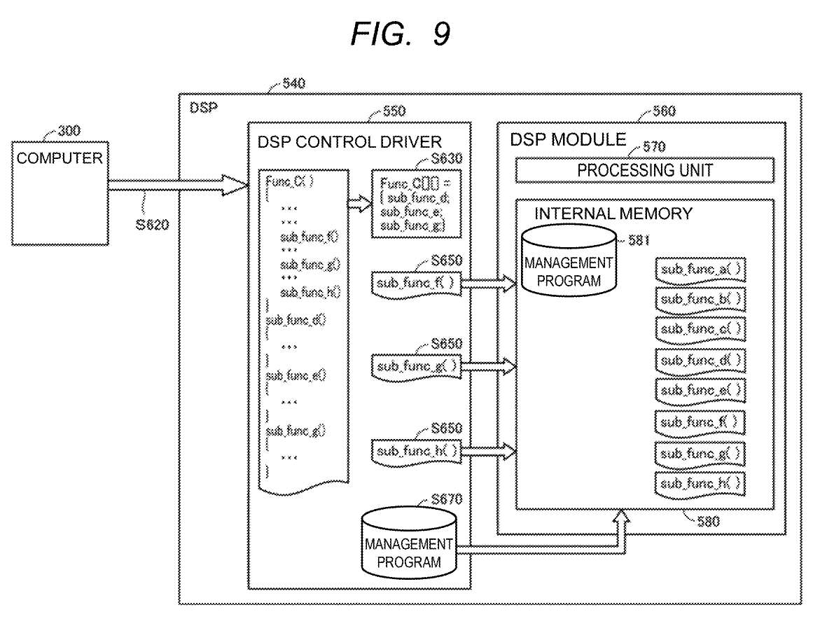

Referring to FIGS. 6 and 9, a description will be given of yet another control structure of DSP540 in a certain situation. FIG. 9 is a diagram representing an aspect of the process executed when adding operation processing (Func_C) to DSP540. Operation processing (Func_C) is composed of each function (sub_func_f, sub_func_g, sub_func_h) that realizes the processing. Also, the function group that composes Func_B and the function group that composes Func_C both overlap in that they include the function (sub_func_g). Note that the same numbers are assigned to the same processes as described above. Therefore, the description of the same process may not be repeated.

In step S620, DSP540 receives data (binary data) of the operation processing program from the computer operated by the user. For example, if the user wishes to execute operation processing (Func_C), the binary data of the operation processing (Func_C) is input from computer 300 to DSP control driver 550.

In step S630, DSP control driver 550 analyzes the operation processing program (binary data of operation processing (Func_C)). In step S640, DSP control driver 550 obtains information on the locations where functions are used in the program and on the functions used and generates configuration information.

In step S650, DSP control driver 550 uploads each function (sub_func_f, sub_func_f) to DSP module 560. Function (sub_func_g) is excluded from the current upload because it was uploaded to internal memory 580 during the addition of operation processing (Func_B). Internal memory 580 stores the uploaded functions.

At step S680, the DSP540 finishes the initialization of the DSP control driver 550. As a result, each function that implements the operation processing (Func_A, Func_B, Func_C) resides in the DSP540. The operation unit 570 refers to the management program 581 and executes each function to implement the operation processing (Func_A, Func_B, Func_C).

### Processing at the Time of DSP Execution

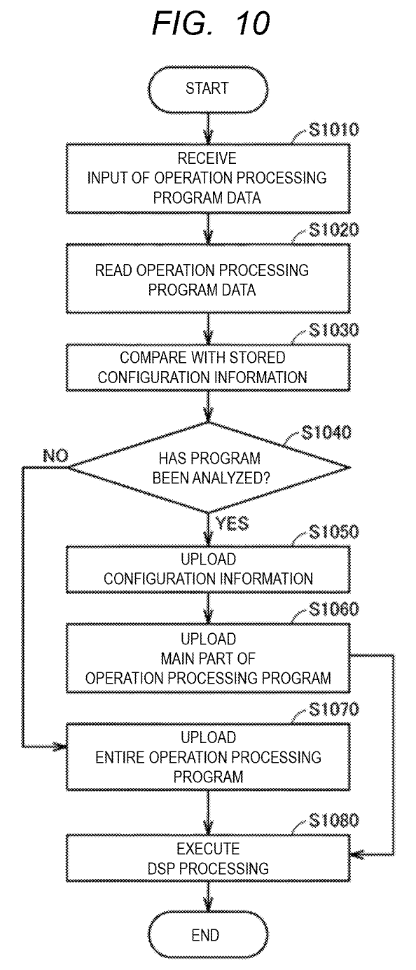

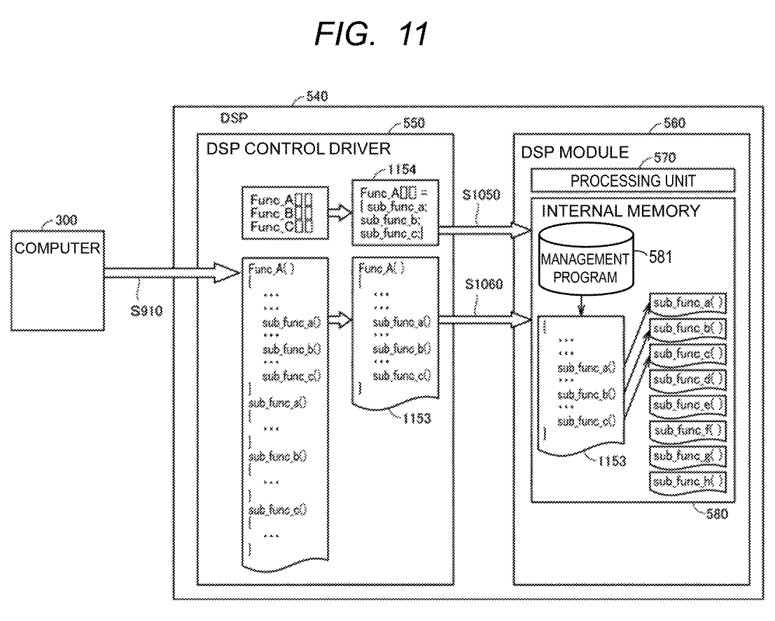

With reference to FIGS. 10 and 11, other control structures of the DSP540 are described. FIG. 10 is a flowchart showing part of the processing executed by the DSP540 according to a certain aspect. FIG. 11 is a diagram showing an aspect of the execution of operation processing in the DSP540.

At step S1010, the DSP540 receives input of program data for operation processing from a computer 300 operated by the user. When the DSP control driver 550 detects the input of program data for operation processing, it analyzes the program data and acquires configuration information 1154 including each function that implements the operation processing.

At step S1020, the DSP control driver 550 reads the program data (configuration information) for operation processing from the DSP module 560.

At step S1030, the DSP control driver 550 compares the acquired configuration information 1154 (step S1010) with the configuration information read from the DSP module 560.

At step S1040, the DSP540 determines whether the operation processing program data has been analyzed. If the DSP540 determines that the program data for operation processing has been analyzed (YES at step S1040), it uploads the configuration information to the DSP module 560 at step S1050. If not (NO at step S1040), the DSP540 switches control to step S1070.

At step S1060, the DSP540 uploads the main part 1153 of the operation processing program to the DSP module 560. At step S1070, the DSP540 uploads the entire operation processing program to the DSP module 560.

At step S1080, the DSP540 activates the DSP module 560. The DSP540, with the operation unit 570 of the DSP module 560, executes the management program 581. The operation unit 570 refers to the uploaded configuration information 1154 and calls each function (sub_func_a(), sub_func_b(), sub_func_c()) necessary for executing the operation processing (Func_A).

### Addition and/or Deletion of Operation Processing

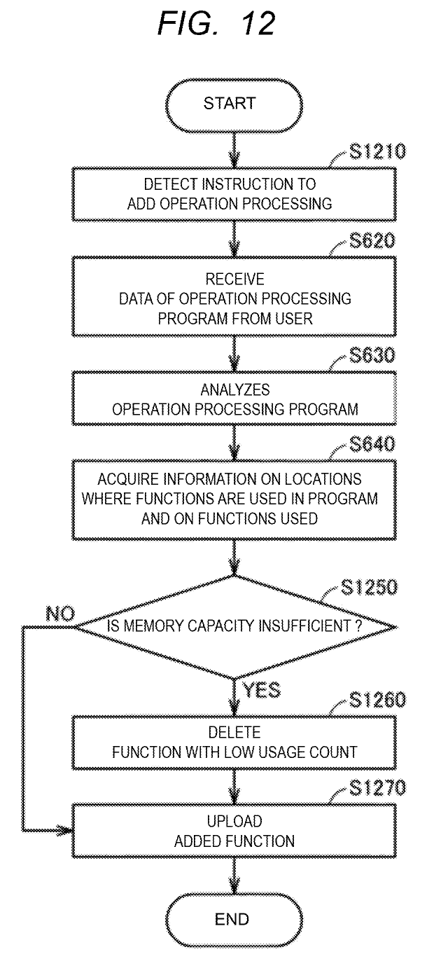

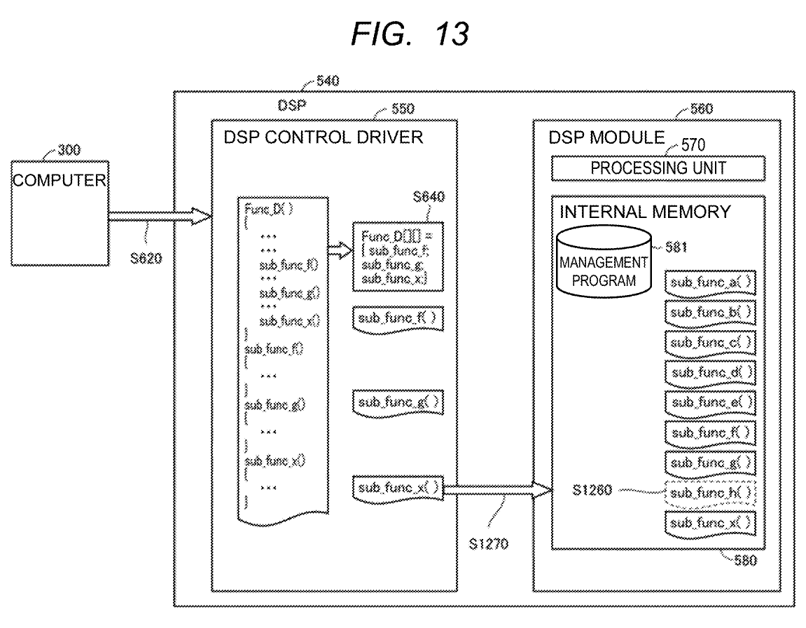

With reference to FIGS. 12 and 13, other control structures of the DSP540 are described. FIG. 12 is a flowchart showing part of the processing for adding operation processing by the DSP540 according to another aspect. FIG. 13 is a diagram showing an aspect of the execution of operation processing in the DSP540 according to another aspect. In the following example, the operation processing (Func_D) that the user wants to perform consists of each function (sub_func_f(), sub_func_g(), sub_func_x()). And the group of functions (sub_func_f(), sub_func_g()) is already stored in the DSP module 560. Note that the same numbers are assigned to the same processes as described above. Therefore, the description of the same process may not be repeated.

At step S1210, the DSP540 detects an instruction to add operation processing. At step S620, the DSP540 receives data (binary data) of the operation processing program from a computer operated by the user. For example, if the user wishes to add operation processing (Func_D) to the DSP540, the binary data of the operation processing (Func_D) is input from the computer 300 to the DSP control driver 550.

At step S630, the DSP control driver 550 analyzes the operation processing program (binary data of operation processing (Func_D)). At step S640, the DSP control driver 550 acquires information on the locations where functions are used in the program and on the functions used and generate configuration information.

At step S1250, the DSP540 refers to the usage status of the internal memory 580 and determines whether the memory capacity is insufficient. If the DSP540 determines that the memory capacity is insufficient (YES at step S1250), it deletes a function with a low usage count (in the example of FIG. 13, sub_func_h()) at step S1260. The function selected for deletion is, for example, the function with the least usage count or a function whose usage count falls below a predetermined reference count. Information on usage count is maintained by the management program 581. If not (NO at step S1250), at step S1270, the DSP540 uploads the added function (sub_func_x()) to the DSP module 560. Thereafter, the DSP540 finishes the process of adding operation processing.

### Selective Deletion of Operation Processing

In yet another aspect, the DSP540 can delete operation processing based on user selection. In this case, the DSP540 excludes from deletion those functions that are used in operation processing not designated for deletion among the functions constituting the operation processing designated for deletion.

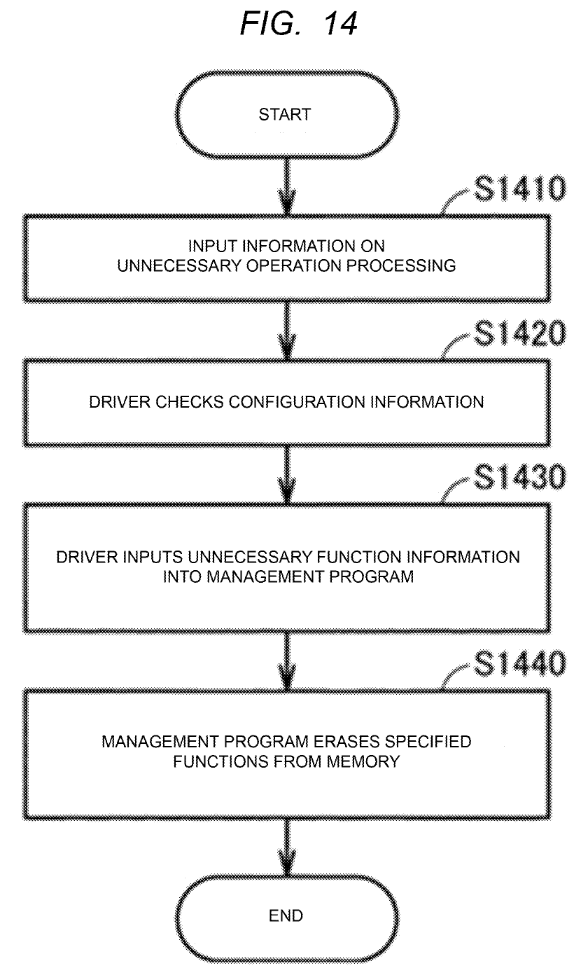

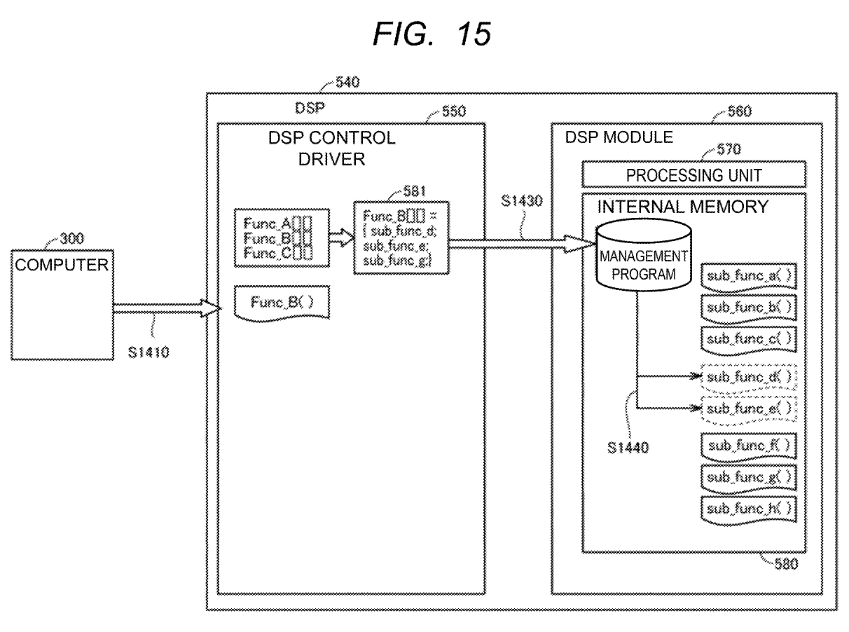

Therefore, with reference to FIGS. 14 and 15, other control structures of the DSP540 are described. FIG. 14 is a flowchart showing part of the processing executed by the DSP540 to delete operation processing based on user instructions according to another aspect. The same numbers are assigned to the same processes as described above. Therefore, the description of the same process may not be repeated. FIG. 15 is a diagram showing an aspect of the execution of operation processing in the DSP540 according to another aspect. In the following example, the operation processing (Func_B) is designated for deletion by the user. Note that the function (sub_func_g()) constituting the operation processing (Func_B) also constitutes the operation processing (Func_C) not designated for deletion.

At step S1410, the DSP540 receives input of information on unnecessary operation processing from the computer 300. The information on unnecessary operation processing is, for example, information for identifying the operation processing (Func_B) designated for deletion (e.g., the name of the operation processing).

At step S1420, the DSP control driver 550 checks the configuration information 554 and identifies each function constituting the operation processing (Func_B). In the illustrated example, the identified functions are functions (sub_func_d(), sub_func_e(), sub_func_g()). Furthermore, the DSP control driver 550 refers to the configuration information 554 to determine whether other operation processing (e.g., Func_A, Func_C) stored in the DSP540 uses each of the identified functions. If any one of the functions is used by other operation processing, the functions used by other operation processing are excluded from deletion. In the illustrated example, two functions (sub_func_d() and sub_func_e()) are subject to deletion.

At step S1430, the DSP control driver 550 inputs unnecessary function information, i.e., information identifying the functions designated for deletion, into management program 581 of the DSP module 560. In the illustrated example, sub_func_d() and sub_func_e() are input as information identifying the functions.

At step S1440, the operation unit 570 of the DSP module 560 executes the management program 581. When this program is executed, the data of the two functions (sub_func_d() and sub_func_e()) is erased from the internal memory 580. As a result, the free space in internal memory 580 increases, allowing new functions to be stored.

Note that the specification of functions to be deleted is not limited to those directly specified by the user. For example, the DSP540 may present operation processing or functions that have not been used for a predetermined period as candidates for deletion to the computer 300. When the user selects the operation processing or function, the DSP540 deletes the selected operation processing or function.

### Acquisition of Management Information for Operation Processing

In another aspect, the DSP may have multiple DSP modules (hereinafter also referred to as "cores"). In this case, the user can specify the DSP module that executes the operation processing when requesting the execution of operation processing by the DSP. For example, the user can specify the DSP module storing the functions constituting the operation processing and have the operation processing executed. By doing so, the DSP does not need to upload the functions to a DSP module that does not have the functions constituting the operation processing, thereby suppressing the overall operation processing time from becoming longer.

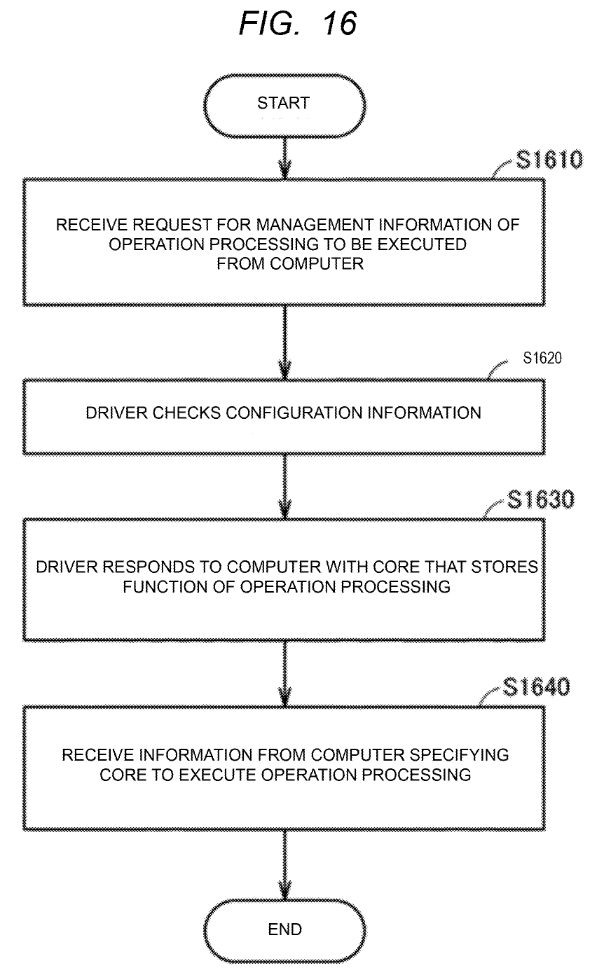

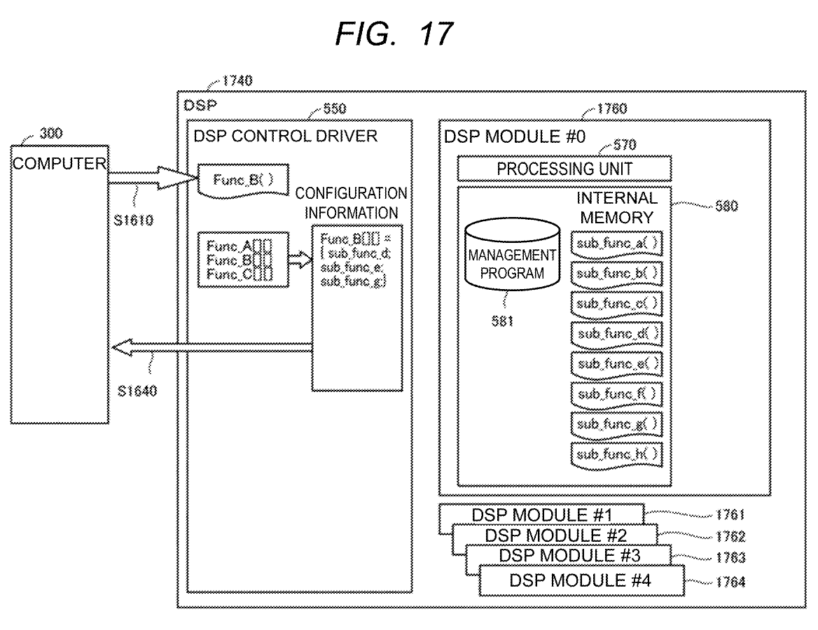

Therefore, with reference to FIGS. 16 and 17, the DSP1740 according to another aspect is described. FIG. 16 is a flowchart showing part of the processing executed by the DSP1740 according to another aspect. FIG. 17 is a diagram illustrating one embodiment of the configuration and execution of processing of DSP1740. DSP1740 includes a DSP control driver 550 and multiple DSP modules 1760, 1761, 1762, 1763, 1764.

When the user requests management information of processing from the computer 300, the process shown in FIG. 16 is executed. First, in step S1610, DSP1740 receives a request for management information of the processing to be executed from the computer 300. The request includes information specifying the processing (for example, Func_B).

In step S1620, when the DSP control driver 550 of DSP1740 receives the request, it checks the configuration information it holds based on the information. DSP1740 has multiple DSP modules 1760, 1761, 1762, 1763, 1764. Therefore, the configuration information includes not only information on the functions constituting the processing but also identification information of the processing and functions stored in each DSP module. The DSP control driver 550 identifies the DSP module (core) in which the function of the specified processing (Func_B) is stored based on the configuration information. The DSP control driver 550 designates the identification information of the identified DSP module as the recommended core suitable for the processing.

In step S1630, the DSP control driver 550 responds to the computer 300 with the identification information of the DSP module (recommended core) storing the function of the processing (Func_B) specified by the user. By confirming the response, the user can know the DSP module for which uploading program data is unnecessary or can be minimized before executing the processing. The user gives an instruction to the computer 300 to execute the processing (Func_B) on the recommended core.

In step S1640, DSP1740 receives information from the computer 300 specifying the core to execute the processing, and the DSP control driver 550 executes the processing according to the instruction.

### Relocation of Functions with Low Usage

In other situations, the DSP can relocate each function that implements the processing after executing a certain processing. Here, relocation refers to changing the location where a function is stored from one DSP module to another. The timing of relocation can be, for example, when the processing is finished, when the number of times each function has been executed reaches a predetermined number, or when new processing is input to the DSP. In other situations, relocation may be performed when an instruction for relocation is input and a predetermined time has elapsed since the last relocation.

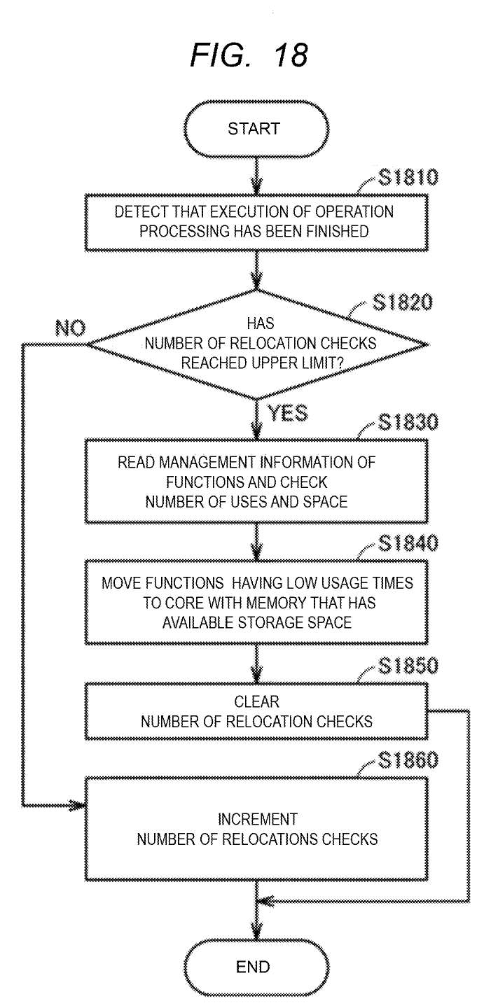

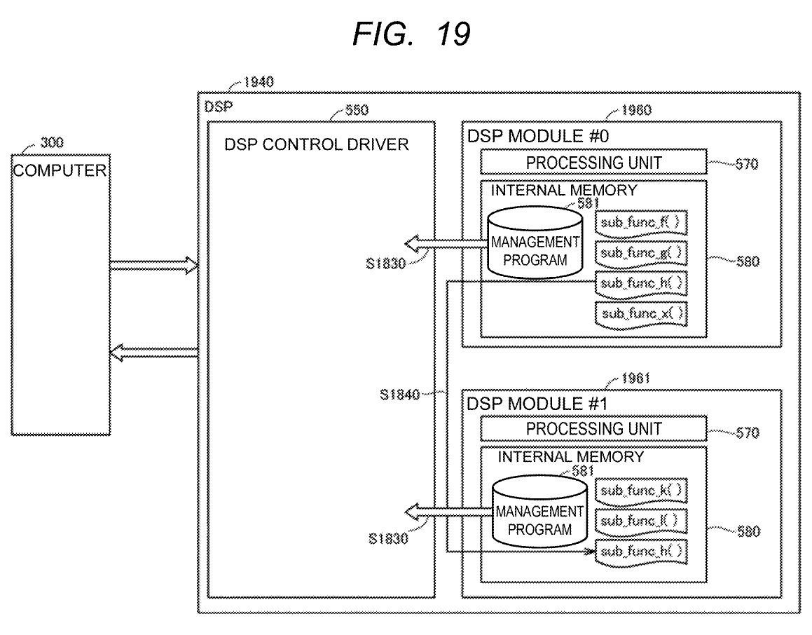

Therefore, with reference to FIGS. 18 and 19, the relocation of functions based on the number of uses will be explained. FIG. 18 is a flowchart illustrating part of the processing executed by the DSP control driver 550 according to a certain situation. FIG. 19 is a diagram illustrating the configuration of DSP1940 and part of the processing performed internally according to a certain situation. DSP1940 includes a DSP control driver 550 and DSP modules 1960, 1961. Each of DSP modules 1960, 1961 includes a processing unit 570 and internal memory 580.

Referring to FIG. 18, in step S1810, the DSP control driver 550 detects that the execution of processing by DSP modules 1960, 1961 has been finished.

In step S1820, the DSP control driver 550 determines whether the number of relocation checks held has reached a predetermined upper limit. If the DSP control driver 550 determines that the number has reached the upper limit (YES in step S1810), it switches control to step S1830. If not (NO in step S1810), the DSP control driver 550 switches control to step S1860.

In step S1830, the DSP control driver 550 accesses DSP modules 1960, 1961 respectively. The DSP control driver 550 reads management information of functions from the management program 581 stored in each internal memory 580. Furthermore, the DSP control driver 550 refers to the management information to check the number of uses of each function by each processing and the availability of storage space in the internal memory 580.

More specifically, the DSP control driver 550 identifies functions with low usage and internal memory 580 with available storage space. Identifying functions with low usage may include identifying the function with the least usage among multiple functions or identifying one or more functions with usage less than a predetermined number. Internal memory 580 with available storage space is identified by referring to the memory address.

In step S1840, the DSP control driver 550 changes the storage location of the binary data of the function identified as having low usage. Specifically, the DSP control driver 550 moves from the currently holding DSP module to another DSP module with internal memory 580 that has available storage space. In the example of FIG. 19, first, the DSP control driver 550 copies the binary data of the function (in the example of FIG. 19, sub_func_h()) stored in DSP module 1960 to DSP module 1961. The DSP control driver 550 compares the binary data of the function stored in DSP module 1960 with the binary data of the function stored in DSP module 1961. If these binary data match, the DSP control driver 550 erases the binary data of the function (sub_func_h()) stored in the movement source DSP module 1960. If these binary data do not match, the DSP control driver 550 executes the copy again. After confirming that the binary data match, the original binary data is erased, preventing the loss of function data during relocation.

In step S1850, the DSP control driver 550 clears the number of relocation checks. In step S1860, the DSP control driver 550 increments the number of relocations checks by one.

Through such processing, when DSP1940 has multiple DSP modules, the usage of storage space in the internal memory 580 included in each DSP module can be improved, thereby increasing available capacity. This makes it possible to add processing executed by DSP1940.

<Relocation of Functions with High Usage Frequency>

In yet another situation, the DSP can perform relocation to consolidate functions with high usage frequency into a single DSP module. The timing of relocation can be, for example, when the processing is finished, when the number of times each function has been executed reaches a predetermined number, or when new processing is input to the DSP. In yet another situation, relocation may be performed when an instruction for relocation is input, or when a predetermined time has elapsed since the last relocation.

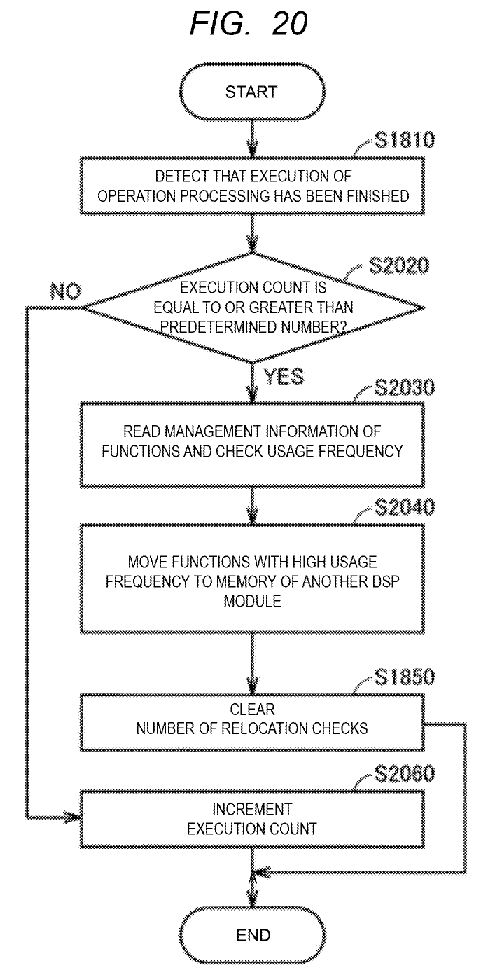

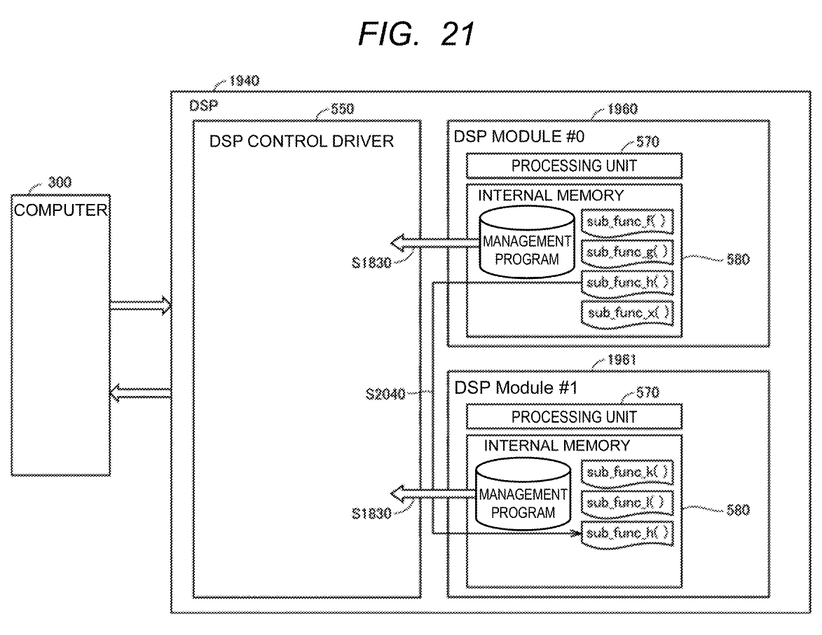

Therefore, with reference to FIGS. 20 and 21, the relocation of functions based on usage frequency will be explained. FIG. 20 is a flowchart illustrating part of the processing executed by the DSP control driver 550 according to another situation. The same step numbers are assigned to the same processing as described above. Therefore, the explanation of the same processing may not be repeated. FIG. 21 is a diagram illustrating the configuration of DSP1940 and part of the processing performed internally according to another situation. The hardware configuration of DSP1940 shown in FIG. 21 is realized by the same configuration as the hardware configuration of DSP1940 shown in FIG. 19. The same reference numerals are assigned to the same elements. Therefore, the explanation of the same elements may not be repeated.

Referring to FIG. 20, in step S2020, the DSP control driver 550 determines whether the execution count of each function is equal to or greater than a predetermined number in response to detecting the finish of processing execution. The functions to be determined may be only those of the processing that was executed immediately before, or all processing stored in DSP1940. If the DSP control driver 550 determines that each execution count is equal to or greater than a predetermined number (YES in step S2020), it switches control to step S2030. If not (NO in step S2020), the DSP control driver 550 switches control to step S2060.

In step S2030, the DSP control driver 550 reads management information of functions from the management program 581 stored in each internal memory 580. Furthermore, the DSP control driver 550 refers to the management information to check the usage frequency of each function by each processing. For example, the DSP control driver 550 identifies functions with a usage frequency equal to or greater than a predetermined frequency and checks the size of their binary data.

In step S2040, the DSP control driver 550 copies the binary data of the identified function to the module where functions should be consolidated (in the example of FIG. 21, DSP module 1961). Subsequently, the DSP control driver 550 verifies whether the copy source binary data matches the copy destination binary data as described above, and if they match, it erases the copy source binary data. The module to which functions should be aggregated is, for example, a DSP module specified in advance as the aggregation destination, or a DSP module with a large number of frequently used functions.

At step S2060, the DSP control driver 550 increments the execution function of the moved function.

As described above, according to the present embodiment, the operation processing program that the user wishes to execute is composed of several functions. The DSP control driver that constitutes the DSP analyzes the operation processing program and stores the functions that constitute the operation processing. The DSP control driver further uploads the functions and management program to the DSP module included in the DSP. When the user requests operation processing, the DSP can use the uploaded functions, so the DSP control driver does not need to upload the entire program data for the operation processing. This reduces the time required for operation processing by the DSP.

Although the invention made by the present inventor has been specifically described based on the embodiment, the present invention is not limited to the as described above embodiment, and it is needless to say that various modifications can be made without departing from the gist thereof.

What is claimed is:

1. A method executed by a computer, comprising:
receiving, by a control unit of the computer, a request for operation processing;
based on the fact that a plurality of functions for realizing the operation processing have been uploaded to the processing unit of the computer, uploading, by the control unit, to the processing unit, a main program that calls each of the plurality of functions and configuration information representing the configuration of the operation processing; and
executing, by the processing unit, the main program and the plurality of functions according to the configuration information.

2. The method according to claim 1, further comprising:
receiving input of a content of the operation processing before the request;
by the control unit, analyzing the content of the operation processing and generating configuration information indicating the configuration of the operation processing; and
storing the configuration information in the computer.

3. The method according to claim 2, further comprising, uploading, by the control unit, a plurality of functions constituting the input operation processing to the processing unit.

4. The method according to claim 1, further comprising:
receiving, by the computer, input of program data for realizing new operation processing; and
uploading, to the processing unit, functions not uploaded to the processing unit among the plurality of functions for realizing the new operation processing.

5. The method according to claim 1, further comprising, deleting, by the processing unit, a function based on a deletion instruction from the control unit.

6. The method according to claim 1, wherein the computer includes a plurality of processing units, and wherein the method further comprises:
receiving input of information specifying the operation processing to be executed; and
outputting information specifying a processing unit suitable for executing the specified operation processing among the plurality of processing units based on the configuration information.

7. The method according to claim 1, wherein the computer includes a plurality of processing units, and wherein the method further comprises, changing, by the control unit, the processing unit in which the function is stored to another processing unit based on the fact that the number of times the function is used is less than a predetermined number.

8. The method according to claim 1, wherein the computer includes a plurality of processing units, and wherein the method further comprises, changing, by the control unit, the processing unit in which the function is stored to another processing unit based on the fact that the frequency of use of the function is greater than a predetermined frequency.

9. An operation device comprising a control unit and a processing unit,
wherein the control unit receives a request for operation processing and uploads to the processing unit a main program that calls each of the plurality of functions and configuration information representing the configuration of the operation processing based on the fact that the plurality of functions for realizing the operation processing have been uploaded to the processing unit, and
wherein the processing unit executes the main program and the plurality of functions according to the configuration information.

10. The operation device according to claim 9, wherein the control unit further receives input of a content of the operation processing, analyzes the content of the operation processing, generates configuration information indicating the configuration of the operation processing, and stores the configuration information in the operation device.

11. The operation device according to claim 10, wherein the control unit uploads a plurality of functions constituting the input operation processing to the processing unit.

12. The operation device according to claim 9, wherein the control unit receives input of program data for realizing new operation processing, and uploads to the processing unit functions not uploaded to the processing unit among the plurality of functions for realizing the new operation processing.

13. The operation device according to claim 9, wherein the control unit instructs the processing unit to delete a function, and the processing unit deletes the function based on the instruction.

14. The operation device according to claim 9, wherein the operation device includes a plurality of processing units, and the control unit receives input of information specifying the operation processing to be executed, and outputs information specifying a processing unit suitable for executing the specified operation processing among the plurality of processing units based on the configuration information.

15. The operation device according to claim 9,
wherein the operation device includes a plurality of processing units, and
wherein the control unit changes the processing unit in which the function is stored to another processing unit based on the fact that the number of times the function is used is less than a predetermined number.

16. The operation device according to claim 9,
wherein the operation device includes a plurality of processing units, and
wherein the control unit changes the processing unit in which the function is stored to another processing unit based on the fact that the frequency of use of the function is greater than a predetermined frequency.
